(19) United States
(12) Patent Application Publication
(10) Pub. No.: US 2018/0013169 A1
(43) Pub. Date: Jan. 11, 2018

(54) LITHIUM ION SECONDARY BATTERY

(71) Applicant: NEC Corporation, Tokyo (JP)

(72) Inventors: Daisuke KAWASAKI, Tokyo (JP); Kenichi SHIMURA, Tokyo (JP); Hitoshi ISHIKAWA, Tokyo (JP)

(21) Appl. No.: 15/534,241

(22) PCT Filed: Dec. 8, 2015
(86) PCT No.: PCT/JP2015/084434

§ 371 Date: Jun. 8, 2017

(30) Foreign Application Priority Data
Dec. 11, 2014 (JP) 2014-250873

(51) Int. Cl. H01M 10/0525; H01M 2/16; H01M 4/587; H01M 4/525; H01M 4/02

(52) U.S. Cl. CPC H01M 10/0525; H01M 4/587; H01M 4/525; H01M 2/16; H01M 2004/028; H01M 2220/20

(57) ABSTRACT

A secondary battery in which heat resistance is excellent and the formation of lithium dendrite is suppressed is provided. The present invention relates to a secondary battery comprising an electrode element comprising a positive electrode, a negative electrode and a separator, wherein the negative electrode comprises a carbon material (a) capable of absorbing and desorbing lithium ions and an oxide (b) capable of absorbing and desorbing lithium ions, and the separator comprises 50% by mass or more of a non-woven fabric having a thermal melting or thermal decomposition temperature of 160° C. or more.

### TECHNICAL FIELD

The present invention relates to a secondary battery, in particular, a secondary battery in which a highly heat resistant non-woven fabric separator is used and the formation of lithium dendrite in a negative electrode is suppressed, and to a method of producing the same.

### BACKGROUND ART

A non-aqueous electrolyte secondary battery such as a lithium ion secondary battery has been widely put into practical use as batteries for notebook type personal computers, mobile phones and the like because of its advantages such as high energy density and excellent long-term reliability. In recent years, the performance of an electronic device has been improved and use in electric vehicles and the like have been advanced, and thus further improvement of battery characteristics such as capacity, energy density, lifetime, safety and the like are strongly desired.

As a means for increasing the capacity of the secondary battery, a metal-based negative electrode active material has attracted attention in recent years. For example, Patent Document 1 discloses an electrical conductive silicon composite in which the surface of a particle is coated with carbon and wherein the particle has a structure in which a microcrystalline silicon is dispersed in a silicon compound.

On the other hand, in the high-performance secondary battery with improved capacity and energy density, safety considerations are more required. As a means for improving the safety of a secondary battery, it is promising to improve the performance of a separator, and thus highly heat resistant separators and the like have been studied. As a highly heat resistant separator, for example, Patent Document 2 describes a separator that comprises fibers having a melting point of 150° C. or more such as aramid and/or polyimide and prevents contraction at abnormal heat generation.

### CITATION LIST

### Patent Document

Patent Document 1: Japanese Patent Laid-Open Publication No. 2004-47404
Patent Document 2: Japanese Patent Laid-Open Publication No. 2006-59717

### SUMMARY OF INVENTION

### Technical Problem

However, in the secondary battery using the separator described in Patent Document 2, when lithium is deposited on a negative electrode, there have been a problem that deposited lithium tends to be in the form of dendrite. When dendrites formed on the negative electrode grow and reach the positive electrode, there is a fear that short-circuit occurs and the safety of the secondary battery is impaired. Even when the short-circuit does not occur, the formed dendrite increases the frequency of self-discharge failure. Further, when the dendrite falls off from the negative electrode, lithium loses its function as a carrier, which causes reduction in capacity of the secondary battery. Furthermore, lithium deposited in the form of dendrite has a large specific surface area and thus has high reactivity with the electrolyte, leading to the problem that causes the cell characteristic failure.

The present invention has been made in view of the above problems, and the objective is to provide a secondary battery in which a highly heat resistant non-woven fabric separator is used and the formation of lithium dendrite in the negative electrode is suppressed.

### Solution to Problem

One aspect of the present invention relates to a secondary battery having an electrode element comprising a positive electrode, a negative electrode and a separator, wherein

the negative electrode comprises a carbon material (a) capable of absorbing and desorbing lithium ions and an oxide (b) capable of absorbing and desorbing lithium ions, and

the separator comprises 50% by mass or more of a non-woven fabric having a thermal melting or thermal decomposition temperature of 160° C. or more.

### Advantageous Effect of Invention

According to the present invention, it is possible to provide a secondary battery which is excellent in heat resistance and in which the formation of lithium dendrite in the negative electrode is suppressed.

### BRIEF DESCRIPTION OF DRAWING

FIG. 1 is a schematic configuration diagram of a laminate type secondary battery according to one embodiment of the present invention.

FIG. 2 is an exploded perspective view showing the basic structure of a film-packaged battery.

FIG. 3 is a cross-sectional view schematically showing a cross section of the battery in FIG. 2.

### DESCRIPTION OF EMBODIMENTS

The present inventors have found that, in the secondary battery using a highly heat resistant separator as described above, when the negative electrode comprising a carbon material capable of absorbing and desorbing lithium ions and an oxide capable of absorbing and desorbing lithium ions is used, a secondary battery in which the lithium deposition on the negative electrode is suppressed, thereby the formation of dendrites is suppressed and self-discharge failure is small can be achieved.

The reason for this is not clear, but the following reasons are conceivable. That is, by using the active material comprising a carbon material and an oxide whose capacity is higher than the carbon material instead of a negative electrode active material consisting of a carbon material, it is possible to improve the acceptance of lithium ions, and also to reduce the thickness of the negative electrode while maintaining the capacity. Further, since the potential gradient in the electrode can be reduced by reducing the thickness of the negative electrode, acceptance of lithium ions is further improved. As a result, it is presumed that deposition of lithium is suppressed and thus the formation of lithium dendrite can be suppressed.

Therefore, the secondary battery according to the present invention comprises an electrode element in which a positive electrode and a negative electrode are laminated via a separator and an outer package enclosing the electrode element and an electrolyte solution, and wherein the separator comprises 50% by mass or more of a non-woven fabric having a thermal melting or thermal decomposition temperature of 160° C. or more and the negative electrode comprises a carbon material (a) capable of absorbing and desorbing lithium ions and an oxide (b) capable of absorbing and desorbing lithium ions.

Hereinafter, an example of a structure of the secondary battery according to the present invention will be described.

### <Separator>

The separator according to the present example embodiment comprises preferably 50% by mass or more, more preferably 80% by mass or more, further preferably 90% by mass or more of a highly heat resistant non-woven fabric. In one example embodiment, it may be particularly preferable to be composed only of highly heat resistant non-woven fabric in some cases.

As a constituent component of the highly heat resistant non-woven fabric according to the present example embodiment, for example, a highly heat resistant resin material may be used. Specifically, it is preferable to use a highly heat resistant resin component having a thermal melting or thermal decomposition temperature of 160° C. or higher, more preferably 180° C. or higher. By using such a highly heat resistant resin component as a constituent material of the separator, safety of the secondary battery can be enhanced. The safety of the secondary battery may be evaluated, for example, by performing a high temperature heating test at 160° C.

Examples of the highly heat resistant resin components include polyethylene terephthalate, cellulose, aramid, polyimide, polyamide, polyphenylene sulfide, and the like. Among them, cellulose, aramid, polyimide, polyamide and polyphenylene sulfide are preferable from the viewpoint of heat resistance. In particular, since heat resistance of the following comonents is 300° C. or more, heat contraction thereof is small and shape retention thereof is good, aramid, polyimide, polyamide and polyphenylene sulfide are more preferable, aramid, polyimide and polyamide are further preferable, and aramid is particularly preferable.

In the present specification, the “thermal melting temperature” represents the temperature measured by differential scanning calorimetry (DSC) in accordance with JIS K 7121, the “thermal decomposition temperature” represents the temperature at which 10% of weight is reduced (10% weight reduction temperature) while the temperature is raised from 25° C. with 10° C./min in the airflow by using a thermogravimetry device, and the “heat resistance is 300° C. or more” means that deformation such as softening is not observed at least at 300° C. In addition, in the present specification, the phrase “thermal melting or thermal decomposition temperature is 160° C. or more” means that lower one of the thermal melting temperature and the thermal decomposition temperature is 160° C. or more, for example, in the case of a resin which decomposes without melting during heating, it means that the thermal decomposition temperature is 160° C. or more.

Aramid is an aromatic polyamide in which one or two or more aromatic groups are directly linked by an amide bond. As the aromatic group, for example, a phenylene group may be exemplified, and two aromatic rings may be bonded by oxygen, sulfur or an alkylene group (for example, methylene group, ethylene group, propylene group or the like). These divalent aromatic groups may have a substituent group and examples of the substituent group include an alkyl group (for example, methyl group, ethyl group, propyl group or the like), an alkoxy group (for example, methoxy group, ethoxy group, propoxy group or the like), and halogen (chloro group or the like). Aramid bonds may be any of para-type or meta-type.

Examples of the aramid preferably used in the present example embodiment include polymetaphenylene isophthalamide, polyparaphenylene terephthalamide, copolyparaphenylene 3,4′-oxydiphenylene terephthalamide, and the like.

As described above, use of the separator having high heat resistance is promising as a means for enhancing the safety (heat resistance) of the secondary battery, but on the other hand, a non-woven fabric composed of the highly heat resistant resin as exemplified above is used for a separator, the formation of lithium dendrite tends to become more pronounced. In contrast, in the present example embodiment, since the formation of lithium dendrite can be suppressed even when a non-woven fabric composed of such a highly heat resistant resin is used, both of safety and reducing cell characteristics failure due to lithium dendrite can be achieved at the same time.

In one example embodiment, a further non-woven fabric that is composed of materials other than the highly heat resistant constituent materials exemplified above may be used together. As a constituent component of such a non-woven fabric, various materials which can be processed into fibers may be used, and examples thereof include, but are not limited to, polypropylene, polyethylene, ceramic short fibers, glass fibers, and the like.

In the present example embodiment, the non-woven fabric represents a sheet-like (including a bag-like) one in which fibers are entwined without being woven together, and a fiber assembly in which fibers are bonded or intertwined by heat, mechanical or chemical action is preferable. The non-woven fabric may be composed of a single fiber or an assembly of two or more kinds of fibers. In addition, two or more kinds of non-woven fabrics may be used in combination.

The average pore diameter of the non-woven fabric in the present example embodiment is preferably 0.01 μm or more, more preferably 0.05 μm or more, further preferably 0.1 μm or more. When the average pore diameter is 0.1 μm or more, better lithium ion permeability can be maintained. The average pore diameter is preferably 1.5 μm or less, more preferably 1 μm or less, and still more preferably 0.5 μm or less. When the average pore diameter is 1.5 μm or less, the formation of dendrites can be further suppressed. From the same viewpoint, it is preferable that the maximum pore size of the non-woven fabric is 5 μm or less. The pore diameter of the non-woven fabric may be measured by the bubble point method described in SIM-F-316 and the mean flow method. Further, the average pore diameter may be the average value of the measured values at arbitrary five areas of the non-woven fabric.

The separator according to the present example embodiment has a porosity of preferably 60% or more, and more preferably 70% or more. For the porosity of the separator, the bulk density is measured in accordance with JIS P 8118 and calculated as follows:

Porosity (%)=[1−(bulk density ρ(g/cm³)/theoretical density ρ₀ of the material (g/cm³))]×100

Other measurement methods include a direct observation method using an electron microscope and a press fitting method using a mercury porosimeter. By setting the porosity within the above range, it is possible to improve the low temperature rate characteristics of the secondary battery, in particular, the low temperature rate characteristics of the secondary battery using the electrolyte solution whose viscosity increases at low temperature. A secondary battery which is excellent in low temperature rate characteristics can also be suitably used for a use application under a low temperature environment such as in-vehicle application.

The separator according to the present example embodiment may comprise other constituent materials in addition to the above non-woven fabric. As other constituent materials, a microporous film made of an olefin-based resin or a highly heat resistant resin may be exemplified.

Examples of the microporous film made of an olefin-based resin include a microporous film made of polyethylene (PE) or polypropylene (PP), and a laminate of these microporous film (three layered laminate and the like).

Examples of the microporous film made of a highly heat resistant resin include a microporous film which is composed of a highly heat resistant resin exemplified as the constituent component of the above non-woven fabric, and a microporous film composed of aramid, polyimide or the like is preferable.

The pore diameter of the microporous film is preferably within the range exemplified as the pore diameter of the non-woven fabric.

Further, the separator according to the present example embodiment may have a layer containing an inorganic filler. Examples of the inorganic filler may include oxides or nitrides of aluminum, silicon, zirconium, titanium and the like, such as alumina, boehmite, fine silica particles, and the like.

The layer containing an inorganic filler may be formed, for example, by applying a dispersion liquid containing the inorganic filler to the above-mentioned non-woven fabric or microporous film and drying it. In order to increase the binding property of the inorganic filler, it is preferred to comprise an organic binder such as polyvinylidene fluoride (PVdF), SBR, CMC, polyvinyl alcohol, acrylic resin, polyurethane resin, epoxy resin, ethylene-vinyl acetate copolymer and ethylene-acrylic acid copolymer, and from the viewpoint of heat resistance, PVdF and SBR are more preferable.

The thickness of the separator (i.e., the thickness including the nonwoven fabric and, if necessary, the microporous film and the inorganic filler layer) in the present example embodiment is not particularly limited, but it is generally preferably 8 μm or more and 30 μm or less, more preferably 9 μm or more and 27 μm or less, and still more preferably 10 μm or more and 25 μm or less. When the thickness of the separator is 10 μm or more, the safety of the secondary battery can be further improved. When the thickness of the separator is 25 μm or less, a good charge and discharge rate can be maintained.

In particular, in the present embodiment, the formation of lithium dendrites is suppressed by using the negative electrode active material comprising an oxide and a carbon material in the negative electrode. Therefore, since there is no need to increase the thickness of the separator for the purpose of suppressing the self-discharge failure due to the formation of the dendrite, there is an advantage that self-discharge failure can be suppressed while maintaining high energy density.

### <Negative Electrode>

The negative electrode according to the present example embodiment comprises a negative electrode current collector and a negative electrode active material layer which is applied to one side or both sides of the negative electrode current collector. The negative electrode active material is bound by the negative electrode binder so as to cover the negative electrode current collector.

### (Negative Electrode Active Material)

In the present example embodiment, the negative electrode active material comprises a carbon material (a) capable of absorbing and desorbing lithium ions and an oxide (b) capable of absorbing and desorbing lithium ions.

As the carbon material (a) capable of absorbing and desorbing lithium ions, graphite (natural graphite, artificial graphite), amorphous carbon (hard carbon, soft carbon and the like), mesocarbon microbeads, diamond-like carbon, carbon nanotube, and the composite thereof may be used. Here, graphite, which has high crystallinity, has high electric conductivity, excellent adhesiveness to an electrode collector formed of a metal such as copper, and excellent voltage flatness. In contrast, since amorphous carbon, which has low crystallinity, is relatively low in volume expansion, it is highly effective to reduce volume expansion of the entire negative electrode, and in addition, deterioration due to non-uniformity such as crystal grain boundary and defect hardly occurs. The carbon material (a) may be used singly or may be used in combination of two or more thereof.

Among them, it is preferable to comprise at least graphite as the carbon material (a). As a graphite, it is more preferable that the graphite in which a spacing of (002) planes, d (002), is 0.3354 nm or more and 0.338 nm or less, and an area ratio of G peak and D peak by Raman spectroscopy is G/D 9. Since such graphite is easy to collapse by pressure, it can function as a cushion for relieving the stress which is generated by expansion and contraction, which is caused by charge and discharge, of the particles of other negative electrode active materials such as oxide (b) capable of absorbing and desorbing lithium ions. In the present specification, the G peak is a peak arising from a crystalline graphite and has a peak at 1580 to 1600 cm⁻¹, and the D peak is a peak arising from amorphous graphite and has a peak at around 1350 cm-1.

The content of the carbon material (a) is preferably 70% by mass or more, more preferably 90% by mass or more, further preferably 94% by mass or more, and particularly preferably 97% by mass or more. By comprising the carbon material (a) in an amount of 70% by mass or more, the volume change of the negative electrode due to charge and discharge can be suppressed and cycle characteristics can be improved. The content of the carbon material (a) in the negative electrode active material is preferably 99.9% by mass or less, more preferably 99.5% by mass or less, and further preferably 99% by mass or less.

As the oxide (b) capable of absorbing and desorbing lithium ions, silicon oxide, aluminum oxide, tin oxide, indium oxide, zinc oxide, lithium oxide, germanium oxide, phosphorus oxide or a composite thereof may be used. In particular, it is preferable that silicon oxide (SiOₓ (wherein 0<x≦2, preferably 0.5<x<1.5) is comprised as the oxide (b). This is because silicon oxide is relatively stable and hardly causes reaction with other compounds, and for example, SiO has the theoretical capacity of 2676 mAh/g (calculated by using 4200 mAh/g as theoretical capacity of Si), which is a high specific capacity as compared to graphite (372 mAh/g), and thus it is possible to reduce the thickness of the negative electrode while maintaining a high capacity. One or more elements selected from nitrogen, boron and sulfur may be added to the oxide (b) in an amount of, for example, 0.1 to 5% by mass. This makes it possible to improve the electrical conductivity of the oxide (b).

It is preferred that the oxide (b) capable of absorbing and desorbing lithium ions wholly or partly has an amorphous structure. The oxide (b) having an amorphous structure can suppress volume expansion of the carbon material (a) and the metal material (c) described later, which are the other negative electrode active materials, and also suppress decomposition of an electrolyte solution. Although the mechanism of this is unclear, the amorphous structure of the oxide (b) may probably have some effect on formation of a film on the interface between the carbon material (a) and an electrolyte solution. Further, the amorphous structure has relatively small numbers of factors associated with non-uniformity such as crystal grain boundary and defects. Whether whole or part of the oxide (b) has an amorphous structure may be checked by X-ray diffraction measurement (general XRD measurement). Specifically, when the oxide (b) does not have an amorphous structure, a peak intrinsic to the oxide (b) is observed, on the other hand, when the whole or part of the oxide (b) has an amorphous structure, a broad peak is observed as the peak intrinsic to the oxide (b).

The content of the oxide (b) in the negative electrode active material is preferably 30% by mass or less, more preferably 10% by mass or less, further preferably 5% by mass or less, particularly preferably 3% by mass or less. When the content of the oxide (b) is 30% by mass or less, good charge-discharge efficiency can be maintained. The content of the oxide (b) in the negative electrode active material is preferably 0.01% by mass or more, more preferably 0.1% by mass or more, and further preferably 0.5% by mass or more, and particularly preferably 1% by mass or more. When the content of the oxide (b) is 0.01% by mass or more, the thickness of the negative electrode can be reduced while a high capacity is maintained, as a result, the effect of suppressing dendrite formation can be sufficient.

The negative electrode active material according to the present example embodiment further comprises a metal material (c) capable of forming an alloy with lithium. As the metal material (c) capable of forming an alloy with lithium, Al, Si, Pb, Sn, In, Bi, Ag, Ba, Ca, Hg, Pd, Pt, Te, Zn, La, or alloy of two or more thereof may be used. In particular, it is preferable to comprise tin (Sn) and/or silicon (Si) as the metal material (c), and it is more preferable to comprise silicon (Si).

In one example embodiment, it is preferable that the metal material (c) is the same metal as the metal constituting the oxide (b). For example, it may be constituted by that silicon oxide (SiOₓ (0<x≦2)) is comprised as the oxide (b) and silicon (Si) is comprised as the metal material (c).

In one example embodiment, it is preferable that the whole or part of the metal material (c) is dispersed in the oxide (b). If at least a part of the metal material (c) is dispersed in the oxide (b), the volume expansion of the entire negative electrode can be more suppressed and also the decomposition of an electrolyte solution can be suppressed. For example, it may have a constitution in which silicon (for example, microcrystalline Si particles) is dispersed in a matrix of amorphous silicon oxide, and in this case, it is preferable that silicon oxide and silicon (Si) are combined so as to form and satisfy SiOₓ (0.5≦x≦1.5). Whether the whole or part of the metal material (c) is dispersed in the oxide (b) may be checked by using transmission electron microscopic observation (general TEM observation) and energy dispersive X-ray spectrometry measurement (general EDX measurement) in combination. Specifically, this may be checked by observing a cross-section of a sample and measuring the oxygen concentration of the metal material (c) particles dispersed in the oxide (b) to confirm that the metal constituting the metal material (c) particle is not converted into an oxide.

When the metal material (c) is comprised as the negative electrode active material, the content of the metal material (c) based on the total of the oxide (b) and the metal material (c) is, for example, preferably 10% by mass or more and 50% by mass or less, and more preferably 20% by mass or more and 40% by mass or less. The total content of the oxide (b) and the metal material (c) in the negative electrode active material is preferably 30% by mass or less.

It is also preferable that the oxide (b) (including particles composed of the oxide (b) and the metal material (c)) is coated with a carbon material. Here, the coating means not only a fusion-bonded state in which the layer-like carbon layer present on the particle surface of the oxide (b) and the particle surface of the oxide (b) are fused at the interface, but also a state in which the particles of the carbon material are localized on the particle surface of the oxide (b) and they are complexed, such as a granulated body. Since the particle surface of the oxide (b) is coated with the carbon material, the electrical conductive network in the negative electrode active material layer can be formed satisfactorily.

The carbon material coating the oxide (b) may be the same as or different from the above carbon material (a) capable of absorbing and desorbing lithium ions. Specifically, examples thereof include the carbon material (a) as the above active material, such as graphite (natural graphite, artificial graphite), amorphous carbon (hard carbon, soft carbon and the like), mesocarbon microbeads, diamond-like carbon, carbon nanotube; fibrous carbon materials (PAN type carbon fiber, pitch type carbon fiber, vapor grown carbon fiber) or coiled carbon materials, which are easy to form an electrical conductive network; and carbon black having high electric conductivity (including acetylene black and Ketjen black).

The content of the carbon material coating the surface of the oxide (b) based on the total mass of the oxide (b) (the total of the oxide (b) and the metal material (c) in the case of comprising the metal material (c)) and the carbon material coating the surface of the oxide (b) is preferably 0.01% by mass or more and 15% by mass or less, and more preferably 0.1% by mass or more and 10% by mass or less. When the coating amount of the carbon material is 0.01% by mass or more, a good electrical conductive network can be formed. The amount of the carbon material coating the surface may be obtained by heating the oxide (b) under an oxidizing atmosphere and calculating from the change in weight caused by oxidization and turning into gas of the carbon material coating the surface.

In the case where the surface of the oxide (b) is coated with the carbon material, the total mass of the carbon material (a) and the carbon material coating the surface of the oxide (b) based on the mass of the negative electrode active material is preferably 70% by mass or more, more preferably 90% by mass or more, and further preferably 94% by mass or more.

The negative electrode active material in which the whole or a part of the oxide (b) has amorphous structure, the metal material (c) is wholly or partially dispersed in the oxide (b) and the oxide (b) is coated with a carbon material may be produced by, for example, the method disclosed in the Japanese Patent Laid-Open publication No. 2004-47404. That is, the oxide (b) is subjected to a CVD process under an atmosphere containing organic gas such as methane gas, and thereby metal material (c) in the oxide (b) becomes a nanocluster and the composite whose surface is coated with the carbon material may be obtained. Alternatively, the negative electrode active material may also be prepared by mixing the oxide (b), the metal material (c) and the particles of the carbon material by a mechanical milling in a stepwise manner.

In the present example embodiment, forms of the carbon material (a), the oxide (b), and the metal material (c) are not particularly limited, but particle-shaped ones may be used, respectively. The average particle diameter of the negative electrode active material is preferably 20 μm or less, more preferably 0.5 μm or more and 15 μm or less, and further preferably 1 μm or more and 10 μm or less. If the average particle diameter of the negative electrode active material is excessively small, the powder falling increases and cycle characteristics may be deteriorated in some cases. If the average particle diameter is excessively large, movement of lithium ions may be inhibited in some cases.

In the case of comprising the metal material (c), for example, an average particle diameter of the metal material (c) may be smaller than an average particle size of the oxide (b) and an average particle diameter of the carbon material (a). In this case, the metal material (c) causing a large volume change associated with charge-discharge has a relatively small particle size, and the oxide (b) and the carbon material (a) causing small volume change have a relatively large particle size, and therefore dendrite generation and micronized powder of an alloy is suppressed more effectively. Moreover, in the course of charge and discharge, absorption and desorption of lithium are performed alternately in order from the larger size particle, the smaller size particle, and the larger size particles, and thereby the generation of residual stress and residual distortion is suppressed. In this case, the average particle diameter of the metal material (c) may be, for example, 10 μm or less, preferably 5 μm or less.

Furthermore, in one example embodiment, it is preferable that at least a part of the carbon material (a), the oxide (b), and if necessary, the metal material (c) and/or an electrically conductive auxiliary material which is described later form a composite. The composite may be prepared by, for example, stepwisely mixing these particles by mechanical milling. It is also preferable to coat the surface of the produced composite with one or more kinds of carbon materials. As a coating method, a method in which the surface of the composite is coated with an organic compound and then baked, a CVD method or the like may be used. Such a composite may be produced by, for example, the method described in the Japanese Patent Laid-Open publication No. 2012-9457.

In another example embodiment, it is also preferable that each particle of the carbon material (a), the oxide (b) and the metal material (c) is bonded with a binder. In such a constitution, the contact between particles made of different materials is point contact, restraint of other particles to each other is small and thus the effect of reducing residual stress and residual strain in the negative electrode active material layer can be enhanced.

The negative electrode active material may be doped with lithium in order to reduce the irreversible capacity of the non-carbon material. Specifically, a method of doping lithium in a state of powder as disclosed in Japanese Patent Laid-Open Publication No. 2011-222151 and a method of applying lithium metal foil to an electrode as disclosed in Japanese Patent Laid-Open Publication No. 2003-123740 and Japanese Patent Laid-Open Publication No. 2005-35357.

### (Negative Electrode Binder)

The negative electrode binder is not limited, but examples thereof include polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, polyamideimide and polyacrylic acid. Among these, a styrene-butadiene copolymer rubber is preferable because binding strength can be obtained in a small amount and energy density can be increased. The amount of the negative electrode binder to be used is preferably 1 to 20 parts by mass based on 100 parts by mass of the negative electrode active material from the viewpoint of the trade-off relationship between “sufficient binding strength” and “high energy production”.

### (Electrically Conductive Auxiliary Material for a Negative Electrode)

To the coating layer comprising the negative electrode active material, an electrically conductive auxiliary material may be added for the purpose of reducing the impedance. Examples of the electrically conductive auxiliary material include scaly, soot-like, fibrous carbonaceous fine particles, such as carbon black, acetylene black, Ketjen black, vapor grown carbon fiber (for example, VGCF manufactured by Showa Denko KK), graphite and the like. The content of the electrically conductive auxiliary material in the total mass of the negative electrode active material, the binder and the electrically conductive auxiliary material is preferably 0.01% by mass or more and 8% by mass or less, more preferably 0.05% by mass or more and 4% by mass or less, and in some cases, 2% by weight or less may be preferable. In the case where the negative electrode comprises a carbon material as an electrically conductive auxiliary material, the total mass of the carbon materials comprised in the negative electrode active material and the electrically conductive auxiliary material based on the negative electrode active material is preferably 70% by mass or more, more preferably 90% by mass or more, and further preferably 94% by mass or more.

### (Negative Electrode Current Collector)

As the negative electrode current collector, in view of electrochemical stability, aluminum, nickel, stainless steel, chromium, copper, silver and alloys thereof are preferable. The shape thereof may be in the form of foil, flat-plate or mesh. In particular, copper or an alloy with copper is preferred.

The negative electrode may be prepared by forming a negative electrode active material layer comprising a negative electrode active material and a negative electrode binder on one side or both sides of a negative electrode current collector. The negative electrode current collector is arranged to have an extended portion connected to a negative electrode terminal, and the negative electrode active material layer is not applied to this extended portion. Examples of the method for forming the negative electrode active material layer include a doctor blade method, a die coater method, a CVD method, and a sputtering method. The negative electrode may also be produced by forming the negative electrode active material layer in advance, and then forming a thin film made of aluminum, nickel, or an alloy thereof on the negative electrode active layer by a method such as vapor deposition or sputtering.

### <Positive Electrode>

The positive electrode according to the present example embodiment comprises a positive electrode current collector and a positive electrode active material layer coated on one side or both sides of the positive electrode current collector. The positive electrode active material is bonded by the positive electrode binder so as to cover the positive electrode current collector.

### (Positive Electrode Active Material)

The positive electrode active material in the present example embodiment is not particularly limited as long as the material can absorbe and desorbe lithium, but from the viewpoint of high energy density, it preferably comprises a compound having a high capacity. As the compound having a high capacity, a lithium nickel composite oxide obtained by substituting a part of Ni of lithium nickelate (LiNiO₂) with other metal elements may be exemplified, and among them, the lithium nickel composite oxide which is so-called high-nickel represented by the following formula (1) is preferably comprised. Such a compound has a high capacity because Ni content is high, and it has a longer lifetime than LiNiO₂ because a part of Ni is substituted.

Li_{α}Ni_{β}Me_{γ}O₂ (1)

In the formula (1), 0.9≦α≦1.5, β+γ=1, 0.6≦β<1, Me is at least one selected from the group consisting of Co, Mn, Al, Fe, Mg, Ba and B.)

In the formula (1), as for α, 1≦α≦1.2 is more preferable. As for β, β≧0.7 is more preferable, β≧0.8 is particularly preferable. Me preferably comprises at least one selected from Co, Mn, Al and Fe, and more preferably comprises at least one selected from Co and Mn.

Examples of the compound represented by the formula (1) include Li_{α}Ni_{β}Co_{γ}Mn_{δ}O₂ (1≦α≦1.2, β+γ+δ=1, β≧0.7, γ≦0.2), Li_{α}Ni_{β}Co_{γ}Al_{δ}O₂ (1≦α≦1.5, β+γ+δ=1, β≧0.7, γ≦0.2) and the like, the compound represented by Li_{α}Ni_{β}Co_{γ}Mn_{δ}O₂ (1≦α≦1.2, β+γ+δ=1, β≧0.8, γ≦0.2) is more preferable. Specifically, for example, LiNi_{0.8}Mn_{0.15}Co_{0.05}O₂, LiNi_{0.8}Co_{0.1}Mn_{0.1}O₂, LiNi_{0.8}Co_{0.15}Al_{0.05}O₂ and the like may be preferably used.

The above high-nickel of lithium nickel composite oxide may be used alone, or may be used in combination of two or more thereof.

It is preferable that the content of the high-nickel of lithium nickel composite oxide in the positive electrode active material is preferably 75% by mass or more, more preferably 85% by mass or more, further preferably 90% by mass or more, particularly preferably 95% or more, and may be 100% by mass.

As the positive electrode active material, in addition to the above high-nickel of lithium nickel composite oxide, other active materials may be comprised. Other active materials are not particularly limited, and a known positive electrode active material(s) may be used. Examples thereof include lithium manganate having a layered structure or lithium manganate having a spinel structure, such as LiMnO₂, LiₓMn₂O₄ (0<x<2), Li₂MnO₃ and LiₓMn_{1.5}Ni_{0.5}O₄ (0<x<2); LiCoO₂, LiNiO₂ or a material in which a part of a transition metal of these is substituted with other metals (excluding those in which the nickel content in the transition metal is 60 mol % or more); a lithium transition metal oxide in which a specific transition metal occupies less than a half of the whole structure, such as LiNi_{1/3}Co_{1/3}Mn_{1/3}O₂; such a lithium transition metal oxide containing Li more excessively than in a stoichiometric composition; and a material having an olivine structure such as LiFePO₄. Further, materials in which these metal oxides are partially substituted by Al, Fe, P, Ti, Si, Pb, Sn, In, Bi, Ag, Ba, Ca, Hg, Pd, Pt, Te, Zn, La and the like may be used. These active materials may be used singly or in combination of two or more.

The positive electrode active material in another example embodiment of the present invention is not particularly limited as long as it can absorb and desorb lithium, and it may be selected from several viewpoints. From the viewpoint of achieving higher energy density, a high capacity compound is preferably contained. Examples of the high capacity compound include lithium acid nickel (LiNiO₂), or lithium nickel composite oxides in which a part of the Ni of lithium acid nickel is replaced by another metal element, and layered lithium nickel composite oxides represented by the following formula (A) are preferred.

Li_{y}Ni₍₁₋ₓ₎MₓO₂ (A)

(wherein 0≦x<1, 0<y≦1.2, and M is at least one element selected from the group consisting of Co, Al, Mn, Fe, Ti, and B.)

In addition, from the viewpoint of high capacity, it is preferred that the content of Ni is high, that is, x is less than 0.5, further preferably 0.4 or less in the formula (A). Examples of such compounds include Li_{α}Ni_{β}Co_{γ}Mn_{δ}O₂ (0<α≦1.2, preferably 1≦α≦1.2, β+γ+δ=1, β≧0.7, and γ≦0.2) and Li_{α}Ni_{β}Co_{γ}Al_{δ}O₂ (0<α≦1.2, preferably 1≦α≦1.2, β+γ+δ=1, β≧0.6, preferably β≧0.7, and γ≦0.2) and particularly include LiNi_{β}Co_{γ}Mn_{δ}O₂ (0.75≦β≦0.85, 0.05≦γ≦0.15, and 0.10≦δ≦0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

From the viewpoint of thermal stability, it is also preferred that the content of Ni does not exceed 0.5, that is, x is 0.5 or more in the formula (A). It is also preferred that particular transition metals do not exceed half. Examples of such compounds include Li_{α}Ni_{β}Co_{γ}Mn_{δ}O₂ (0<α≦1.2, preferably 1≦α≦1.2, β+γ+δ=1, 0.2≦β≦0.5, 0.1≦γ≦0.4, and 0.1≦δ≦0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including these compounds in which the content of each transition metal fluctuates by about 10%).

Two or more compounds represented by the formula (A) may be mixed and used, and, for example, it is also preferred that NCM532 or NCM523 and NCM433 are mixed in the range of 9:1 to 1:9 (as a typical example, 2:1) and used. Or, by mixing a material in which the content of Ni is high (x is 0.4 or less in the formula (A)) and a material in which the content of Ni does not exceed 0.5 (x is 0.5 or more, for example, NCM433), a battery having high capacity and high thermal stability can also be formed.

Examples of the positive electrode active material other than the above materials include lithium manganate having a layered structure or lithium manganate having a spinel structure such as LiMnO₂, LiₓMn₂O₄ (0<x<2), Li₂MnO₃ and LiₓMn_{1.5}Ni_{0.5}O₄ (0<x<2); LiCoO₂, or materials in which a part of the transition metals thereof are substituted with another metal; materials which have Li at a larger amount than the stoichiometric amount in these lithium transition metal oxides, and materials having an olivine structure such as LiFePO₄. Further, materials in which these metal oxides are partially substituted with Al, Fe, P, Ti, Si, Pb, Sn, In, Bi, Ag, Ba, Ca, Hg, Pd, Pt, Te, Zn, La and the like may be used. These active materials may be used singly or in combination of two or more.

### (Positive Electrode Binder)

As the positive electrode binder, the same binder as the negative electrode binder may be used. Among them, from the viewpoint of versatility and low cost, polyvinylidene fluoride or polytetrafluoroethylene is preferable and polyvinylidene fluoride is more preferable. The amount of the positive electrode binder to be used is preferably 2 to 10 parts by mass based on 100 parts by mass of the positive electrode active material from the viewpoint of the trade-off relationship between “sufficient binding strength” and “high energy production”.

### (Electrically Conductive Auxiliary Material for a Positive Electrode)

To the coating layer comprising the positive electrode active material, an electrically conductive auxiliary material may be added for the purpose of reducing the impedance. Examples of the electrically conductive auxiliary material include scaly, soot-like, fibrous carbonaceous fine particles, such as graphite, carbon black, acetylene black, Ketjen black, vapor grown carbon fiber (for example, VGCF manufactured by Showa Denko KK) and the like.

### (Positive Electrode Current Collector)

As the positive electrode current collector, the same current collector as the negative electrode current collector may be used. In particular, as the positive electrode, a current collector using aluminum, an aluminum alloy, and iron, nickel, chromium and molybdenum type stainless steel are preferable.

The positive electrode may be produced, in the same manner as the negative electrode, by forming a positive electrode active material layer comprising a positive electrode active material and a positive electrode binder on a positive electrode current collector.

### <Electrolyte Solution>

As the electrolyte solution of the secondary battery according to the present example embodiment, a non-aqueous electrolyte solution comprising a non-aqueous solvent that is stable at the operating potential of the battery and a supporting salt is preferable.

Examples of the non-aqueous solvent include aprotic organic solvents including cyclic carbonates such as propylene carbonate (PC), ethylene carbonate (EC) and butylene carbonate (BC); open-chain carbonates such as dimethyl carbonate (DMC), diethyl carbonate (DEC), ethyl methyl carbonate (EMC) and dipropyl carbonate (DPC); propylene carbonate derivatives, aliphatic carboxylic acid esters such as methyl formate, methyl acetate and ethyl propionate; ethers such as diethyl ether and ethyl propyl ether; phosphoric acid esters such as trimethyl phosphate, triethyl phosphate, tripropyl phosphate, trioctyl phosphate and triphenyl phosphate; and fluorinated aprotic organic solvents in which at least a part of the hydrogen atoms of these compounds is(are) substituted with fluorine atoms.

Among these, cyclic or open-chain carbonates such as ethylene carbonate (EC), propylene carbonate (PC), butylene carbonate (BC), dimethyl carbonate (DMC), diethyl carbonate (DEC), ethyl methyl carbonate (MEC) and dipropyl carbonate (DPC) are preferably comprised.

The non-aqueous solvent may be used alone, or two or more types may be used in combination.

As the supporting salt, lithium salts such as LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(CF₃SO₂)₂ and the like may be exemplified. As the supporting salt, one type may be used alone, or two or more types may be used in combination. From the viewpoint of cost reduction, LiPF₆ is preferable.

The electrolyte solution according to the present example embodiment may further comprise an additive.

The additive is not particularly limited, but examples thereof includes a fluorinated cyclic carbonate, an unsaturated cyclic carbonate, a cyclic or an open-chain disulfonic acid ester and the like. By adding these compounds, battery characteristics such as cycle characteristics can be improved. This is presumably because these additives decompose during charge and discharge of the secondary battery to form a film on the surface of the electrode active material and suppress decomposition of the electrolyte solution and the supporting salt.

As the fluorinated cyclic carbonate, for example, a compound represented by the following formula (2) may be exemplified.

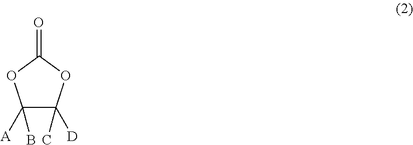

In the formula (2), A, B, C and D are each independently a hydrogen atom, a halogen atom, an alkyl group or a halogenated alkyl group having 1 to 6 carbon atoms, and at least one of A, B, C and D is a fluorine atom or a fluorinated alkyl group. The number of carbon atoms in the alkyl group and the halogenated alkyl group is more preferably 1 to 4, and further preferably 1 to 3.

As the fluorinated cyclic carbonate, compounds in which a part of or all of the hydrogen atom(s) of ethylene carbonate (EC), propylene carbonate (PC), butylene carbonate (BC) and the like is(are) substituted with fluorine atoms may be exemplified, and among them, 4-fluoro-1,3-dioxolan-2-one (fluoroethylene carbonate: FEC) is preferable.

The content of the fluorinated cyclic carbonate in the electrolyte solution is not particularly limited, but 0.01% by mass or more and less than 1% by mass is preferable, 0.05% by mass or more and 0.8% by mass or less is more preferable. By containing 0.01% by mass or more of the fluorinated cyclic carbonate, a sufficient film forming effect can be obtained. When the content is less than 1% by mass, gas generation due to decomposition of the fluorinated cyclic carbonate itself can be suppressed, activity decrease of the metal oxide in the negative electrode active material can be suppressed, and good cycle characteristics can be maintained.

The unsaturated cyclic carbonate is a cyclic carbonate having at least one carbon-carbon unsaturated bond in a molecule, examples thereof include vinylene carbonate compounds such as vinylene carbonate, methyl vinylene carbonate, ethyl vinylene carbonate, 4, 5-dimethyl vinylene carbonate and 4,5-diethyl vinylene carbonate; and vinyl ethylene carbonate compounds such as 4-vinyl ethylene carbonate, 4-methyl-4-vinyl ethylene carbonate, 4-ethyl-4-vinyl ethylene carbonate, 4-n-propyl-4-vinylene ethylene carbonate, 5-methyl-4-vinyl ethylene carbonate, 4,4-divinyl ethylene carbonate, 4,5-divinyl ethylene carbonate, 4, 4-dimethyl-5-methylene ethylene carbonate, 4,4-diethyl-5-methylene ethylene carbonate. Among them, vinylene carbonate and 4-vinyl ethylene carbonate are preferable, vinylene carbonate is particularly preferable.

The content of the unsaturated cyclic carbonate in the electrolyte solution is not particularly limited, but it is preferably 0.01% by mass or more and 10% by mass or less. When the content is 0.01% by mass or more, a sufficient film forming effect can be obtained. When the content is 10% by mass or less, gas generation due to decomposition of the unsaturated cyclic carbonate itself can be suppressed. In the present example embodiment, from the viewpoint of suppressing a decrease in the activity of the metal oxide in the negative electrode active material, 5% by mass or less is more preferable.

As the cyclic or open-chain disulfonic acid ester, for example, a cyclic disulfonic acid ester represented by the following formula (3) or an open-chain disulfonic acid ester represented by the following formula (4) may be exemplified.

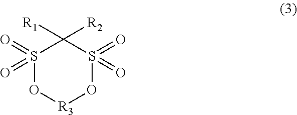

In the formula (3), R₁ and R₂ are each independently a substituent group selected from the group consisting of a hydrogen atom, an alkyl group having 1 to 5 carbon atoms, a halogen group and an amino group. R₃ is an alkylene group having 1 to 5 carbon atoms, a carbonyl group, a sulfonyl group, a fluoroalkylene group having 1 to 6 carbon atoms, or a divalent group having 2 to 6 carbon atoms in which an alkylene unit or a fluoroalkylene unit are bonded through an ether group.

In the formula (3), R₁ and R₂ are each independently preferably a hydrogen atom, an alkyl group having 1 to 3 carbon atoms or a halogen group, and R₃ is more preferably an alkylene group or a fluoroalkylene group having 1 or 2 carbon atoms.

Preferred examples of the cyclic disulfonic acid ester represented by the formula (3) include, but are not limited to, the following compounds.

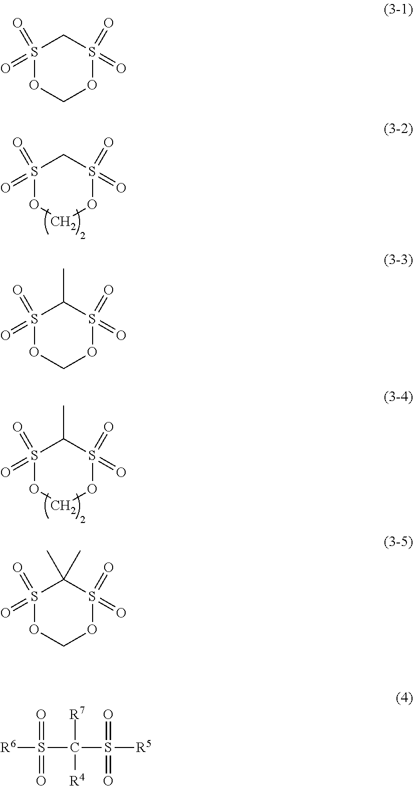

In the formula (4), R⁴ and R⁷ each independently represent an atom or a group selected from a hydrogen atom, an alkyl group having 1 to 5 carbon atoms, an alkoxy group having 1 to 5 carbon atoms, a fluoroalkyl group having 1 to 5 carbon atoms, a polyfluoroalkyl group having 1 to 5 carbon atoms, —SO₂X₃ (X₃ is an alkyl group having 1 to 5 carbon atoms), —SY₁ (Y₁ is an alkyl group having 1 to 5 carbon atoms), —COZ (Z is a hydrogen atom or an alkyl group having 1 to 5 carbon atoms), and a halogen atom. R⁵ and R⁶ each independently represent an atom or a group selected from an alkyl group having 1 to 5 carbon atoms, an alkoxy group having 1 to 5 carbon atoms, a phenoxy group, a fluoroalkyl group having 1 to 5 carbon atoms, a polyfluoroalkyl group having 1 to 5 carbon atoms, a fluoroalkoxy group having 1 to 5 carbon atoms, a polyfluoroalkoxy group having 1 to 5 carbon atoms, a hydroxyl group, a halogen atom, —NX₄X₅ (X₄ and X₅ each independently represent a hydrogen atom or an alkyl group having 1 to 5 carbon atoms), and —NY₂CONY₃Y₄ (Y₂ to Y₄ each independently represent a hydrogen atom or an alkyl group having 1 to 5 carbon atoms).

In the formula (4), R⁴ and R⁷ are each independently preferably a hydrogen atom, an alkyl group having 1 or 2 carbon atoms, a fluoroalkyl group having 1 or 2 carbon atoms, or a halogen atom, and R⁵ and R⁶ are each independently more preferably an alkyl group having 1 to 3 carbon atoms, an alkoxy group having 1 to 3 carbon atoms, a fluoroalkyl group having 1 to 3 carbon atoms, a hydroxyl group or a halogen atom.

As the preferred compound of the open-chain disulfonic acid ester compound represented by the formula (4), for example, the compound in which R⁴ and R⁷ are hydrogen atoms and R⁵ and R⁶ are methoxy groups may be exemplified, but it is not limited thereto.

The content of the cyclic or open-chain disulfonic acid ester in the electrolyte solution is preferably 0.005% by mass or more and 10% by mass or less, and more preferably 0.01% by mass or more and 5% by mass or less. When the content is 0.005% by mass or more, a sufficient film effect can be obtained. When the content is 10% by mass or less, an increase in the viscosity of the electrolyte solution and an increase in resistance associated therewith can be suppressed.

Additives may be used singly or in combination of two or more. When two or more kinds of additives are used in combination, the total content of the additives in the electrolyte solution is preferably 10% by mass or less, more preferably 5% by mass or less.

### <Outer Package>

As the outer package, as long as it is stable to an electrolyte solution and has a sufficient vapor barrier, any material may be appropriately selected. For example, in the case of a laminate type secondary battery, a laminate film of polypropylene or polyethylene coated with aluminum, silica, or alumina may be used as the outer package. The outer package may be constituted by a single member or a combination of a plurality of members. Particularly, in view of suppression of volume expansion, an aluminum laminate film is preferably used.

### <Structure of a Secondary Battery>

A secondary battery according to the present example embodiment may have a structure in which an electrode element having a positive electrode and a negative electrode disposed so as to face each other and an electrolyte solution are enclosed in the outer package. For the secondary battery, various types such as a cylindrical type, a planar winding rectangular type, a laminate rectangular type, a coin type, a planar winding laminate type and a laminate type may be selected depending on the structure and shape of the electrode and the like. Although the present invention may be applied to any type of secondary battery, the laminate type is preferable in terms of low cost and excellent flexibility in designing the cell capacity by changing the number of laminated electrodes.

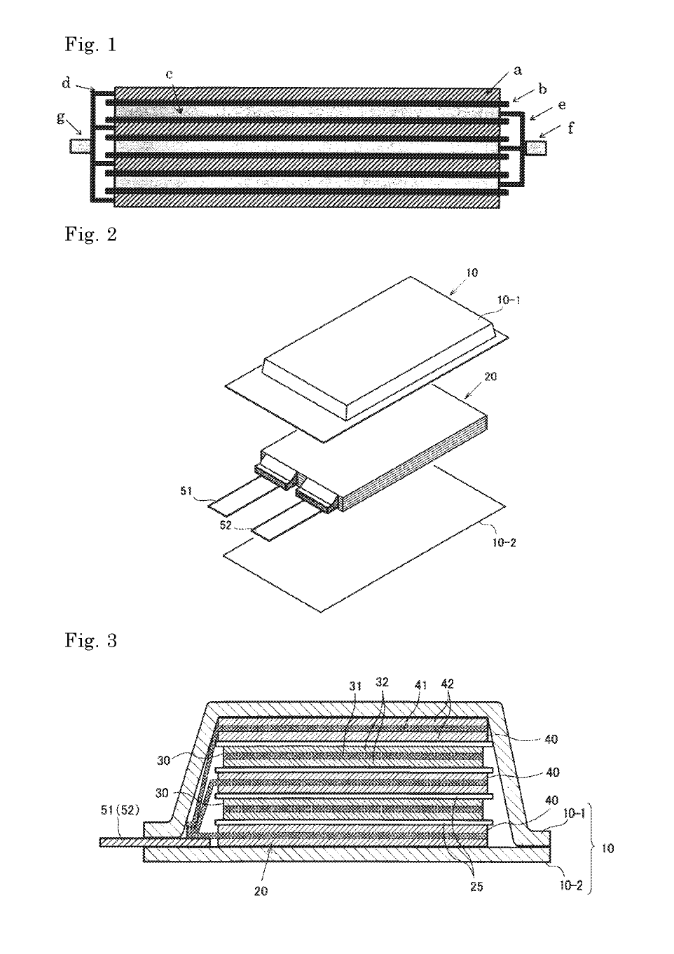

FIG. 1 is a schematic cross-sectional view illustrating the structure of an electrode element (also referred to as “battery element” or “electrode laminate”) of a laminated type secondary battery. In this electrode element, one or a plurality of positive electrodes c and one or a plurality of negative electrodes a are alternately stacked with a separator b sandwiched therebetween. Positive electrode current collectors e of the respective positive electrodes c are welded to one another in end portions not covered with a positive electrode active material so as to be electrically connected to one another, and a positive electrode terminal f is further welded to the welded portion among them. Negative electrode current collectors d of the respective negative electrodes a are welded to one another in end portions not covered with a negative electrode active material so as to be electrically connected to one another, and a negative electrode terminal g is further welded to the welded portion among them.

As another embodiment, a secondary battery having a structure as shown in FIG. 2 and FIG. 3 may be provided. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 3. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

A secondary battery to which the present invention may be applied may have a structure in which the electrode tabs are drawn out on one side of the outer package as shown in FIG. 2. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 3). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 2, the positive electrode tab 51 and the negative electrode tab 52 are drawn out in the same direction from one short side of the film outer package 10 hermetically sealed in this manner.

Of course, the electrode tabs may be drawn out from different two sides respectively. In addition, regarding the arrangement of the films, in FIG. 2 and FIG. 3, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### <Method of Producing a Secondary Battery>

The secondary battery according to the present example embodiment may be produced by a usual method. A method of producing a secondary battery will be described by taking a method of producing a laminate type secondary battery as an example. First, under a dried air or inert gas atmosphere, a positive electrode and a negative electrode are disposed so as to face each other via a separator to form the electrode element. Next, the electrode element is housed in the outer package (container), an electrolyte solution is injected and the electrode is impregnated with the electrolyte solution. Thereafter, the opening of the outer package is sealed to complete the secondary battery.

### <Assembled Battery>

A plurality of secondary batteries according to the present example embodiment may be combined to form an assembled battery. For example, the assembled battery may have a structure in which two or more secondary batteries according to the present example embodiment are used and connected in series, in parallel, or in both. It is possible to adjust the capacity and voltage freely by connecting in series and/or in parallel. The number of secondary batteries included in the assembled battery may be appropriately set depending on the battery capacity and output.

### <Vehicle>

The secondary battery or the assembled battery according to the present example embodiment may be used in a vehicle. Examples of the vehicle according to the present example embodiment include hybrid vehicles, fuel cell vehicles, electric vehicles (including four-wheel vehicles (passenger cars, commercial vehicles such as trucks and buses, light vehicles and the like), two-wheel vehicles (motorcycles) and three-wheel vehicles. Since these vehicles are equipped with the secondary battery according to the present example embodiment, they are excellent in heat resistance, and deposition of lithium dendrite in the negative electrode is suppressed, and thus safety and reliability thereof are high. The vehicle according to the present example embodiment is not limited to an automobile but may be used as various power sources for other vehicles, for example, moving vehicle such as a train.

### <Electric Power Storage Device>

The secondary battery or the assembled battery according to the present example embodiment may be used for an electric power storage device. Examples of the electric power storage device according to the present example embodiment include the device which is connected between a commercial electric power source supplied to an ordinal household and a load of a household electric appliance, and is used as a backup power source or an auxiliary power in case of power outage or the like, and the device which is used for large-scale electric power storage for stabilizing power output with large change in time due to renewable energy, such as photovoltaic power generation.

### EXAMPLES

Hereinafter, an embodiment of the present invention will be explained in details by using examples, but the present invention is not limited to these examples.

### Example 1

Preparation of the battery of the present examples will be described.

### (Positive Electrode)

Lithium nickel composite oxide (LiNi_{0.80}Mn_{0.15}Co_{0.05}O₂) as a positive electrode active material, carbon black as an electric conductive auxiliary material and polyvinylidene fluoride as a binder were weighed at a mass ratio of 90:5:5, and they were kneaded using N-methylpyrrolidone to prepare a positive electrode slurry. The prepared positive electrode slurry was applied to aluminum foil having a thickness of 20 μm and dried, and further pressed to prepare a positive electrode.

### (Negative Electrode)

Artificial graphite particles (average particle size of 8 μm) as the carbon material (a) and a carbon-coated silicon oxide (SiO) particles in which Si nanoclusters are dispersed (carbon coating amount (carbonaceous material mass/total mass of carbonaceous material and oxide silicon): 5% by weight, Si/SiO=1/5, average particle size: 5 μm) as the oxide (b) was weighed in a mass ratio of 97:3 and mixed, to prepare a negative electrode active material. The prepared active material, carbon black as an electrically conductive auxiliary material, and a mixture of 1:1 mass ratio of styrene-butadiene copolymer rubber material:carboxymethyl cellulose as a binder were weighed in a mass ratio of 96:1:3, and they were kneaded using distilled water to prepare a negative electrode slurry. The prepared negative electrode slurry was applied to a copper foil having a thickness of 15 μm as a current collector, dried, and further pressed to obtain a negative electrode (negative electrode capacity: initial charge, per single electrode, was 92 mAh, the electrode area was 30 mm×28 mm, and single electrode was made by double-side coating with 10 mg/cm² on one side.)

### (Separator)

As a separator, a PP aramid composite separator in which a PP microporous film having a thickness of 20 μm and an aramid non-woven fabric film having a thickness of 20 μm were stacked and subjected to heat roll pressing at 130° C. was used. The ratio of the non-woven fabric in the separator was 52% by mass.

### (Electrode Element)

The three positive electrode layers and the four negative electrode layers thus prepared were alternately laminated with a separator interposed therebetween (initial charge capacity of the single cell was 203 mAh, and cell capacity thereafter was 162 mAh). End portions of the positive electrode current collector which was not covered with a positive electrode active material and the negative electrode current collector which was not covered with a negative electrode active material were respectively welded, and a positive electrode terminal made of aluminum and a negative electrode terminal made of nickel were attached by welding to the respective welded portions to obtain an electrode element having a planar laminated structure.

### (Electrolyte Solution)

In a mixed solvent of EC and DEC (volume ratio: EC/DEC=30/70) as a non-aqueous solvent, LiPF₆ as a supporting salt was dissolved so as to be 1 M in the electrolyte solution, to prepare the electrolyte solution.

### (Production of Battery)

The above electrode element was wrapped with aluminum laminate film as an outer package and the electrolyte solution was injected within the outer package, and then the outer package was sealed while the pressure was being reduced to 0.1 atm, thereby producing a secondary battery.

### [Evaluation of the Secondary Battery]

The produced secondary battery was charged at 19 mA for 12 hours and then discharged at 162 mA. After that, charging at 162 mA was carried out at −10° C., and then the battery was disassembled and magnified observation of the surface of the negative electrode was conducted using a scanning electron microscope, and as a result, formation of dendrite was not observed.

### Comparative Example 1

A secondary battery was prepared in the same manner as in Example 1 except that artificial graphite particle was used as a negative electrode active material, and then, the surface of the negative electrode after charge was observed. As a result, dendrite formation was observed.

By comparison between Example 1 and Comparative Example 1, in a secondary battery using a separator comprising 50% by mass or more of a highly heat resistant non-woven fabric, it was confirmed that deposition of Li can be suppressed by using a negative electrode active material comprising graphite and silicon oxide.

### INDUSTRIAL APPLICABILITY

The battery of the present invention can be utilized in various industrial fields that require for an electric power source and in an industrial field concerning transportation, storage and supply of electric energy. Specifically, it can be utilized for, for example, an electric power source of a mobile device such as a mobile phone and a notebook computer; an electric power source of a moving or transport medium including an electric vehicle such as an electric car, a hybrid car, an electric motorcycle and an electric power-assisted bicycle, a train, a satellite and a submarine; a back-up electric power source such as UPS; and an electric power storage device for storing an electric power generated by solar power generation, wind power generation, and the like.

### EXPLANATION OF REFERENCE

a: negative electrode
b: separator
c: positive electrode
d: negative electrode current collector
e: positive electrode current collector
f: positive electrode terminal
g: negative electrode terminal

1. A secondary battery comprising an electrode element comprising a positive electrode, a negative electrode and a separator, wherein
the negative electrode comprises a carbon material (a) capable of absorbing and desorbing lithium ions and an oxide (b) capable of absorbing and desorbing lithium ions, and
the separator comprises 50% by mass or more of a non-woven fabric having a thermal melting or thermal decomposition temperature of 160° C. or more.

2. The secondary battery according to claim 1, wherein the separator has a thickness of 10 μm or more and 25 μm or less.

3. The secondary battery according to claim 1, wherein the non-woven fabric comprises an aramid fiber assembly.

4. The secondary battery according to claim 1, wherein the content of the carbon material (a) capable of absorbing and desorbing lithium ions in a negative electrode active material is 70% by mass or more.

5. The secondary battery according to claim 1, wherein the negative electrode further comprises a metal material (c) capable of forming an alloy with lithium.

6. The secondary battery according to claim 1, wherein the metal constituting the oxide (b) capable of absorbing and desorbing lithium ions and the metal material (c) capable of forming an alloy with lithium are the same elements.

7. The secondary battery according to claim 1, wherein the carbon material (a) capable of absorbing and desorbing lithium ions comprises graphite.

8. The secondary battery according to claim 1, wherein the oxide (b) capable of absorbing and desorbing lithium ions comprises a silicon oxide.

9. The secondary battery according to claim 1, wherein the positive electrode comprises the positive electrode active material comprising a lithium nickel composite oxide represented by the following formula (1):
Li_{α}Ni_{β}Me_{γ}O₂ (1)
(wherein 0.9≦α≦1.5, β+γ=1, 0.6≦β<1, Me is at least one selected from the group consisting of Co, Mn, Al, Fe, Mg, Ba and B.)

10. An assembled battery comprising a plurality of the secondary batteries according to claim 1.

11. A vehicle equipped with the secondary battery according to claim 1.

12. (canceled)

13. (canceled)
